(19) United States
(12) Patent Application Publication
(10) Pub. No.: US 2003/0063776 A1
(43) Pub. Date: Apr. 3, 2003

(54) Walking auxiliary for person with impaired vision

(76) Inventor: Shigemi Sato, Nagano-ken (JP)

Correspondence Address: HARNESS, DICKEY & PIERCE, P.L.C., P.O. BOX 828, BLOOMFIELD HILLS, MI, 48303, US

(21) Appl. No.: 10/245,831

(22) Filed: Sep. 17, 2002

(30) Foreign Application Priority Data
Sep. 17, 2001 (JP) 2001-281519

(51) Int. Cl. G06K 9/00

(52) U.S. Cl. 382/106; 382/154

(57) ABSTRACT

A walking auxiliary is provided for a person with impaired vision which provides sufficient information of obstacles and so on when he takes a walk. This invention includes two CCD cameras 11, 12, an image processing unit 14 which measures a distance to an obstacle based on the image pick-up signals of the CCD cameras 11, 12, converts the stereo information to plane information based on the stereo information obtained from the distance and takes it as a control signal of the actuators, and an actuator control unit 15 for driving an actuator array 16 based on the control signal, and transmits the existence of the obstacle somatosensorially by driving the actuator array 16.

### BACKGROUND OF THE INVENTION

1. Technical Field of the Invention

This invention relates to a walking auxiliary for a person with impaired vision for detecting obstacles when the person with impaired vision takes a walk to assist him in the walk.

2. Prior Art

When a person with impaired vision (also known as dysopia) takes a walk, he walks by using a white stick to detect obstacles and avoid those obstacles.

There is a problem with the white stick described above in that the stick can only catch an object at a point, therefore it gives insufficient information and cannot ensure full safety. Moreover, there are problems in that when a person stands on a flat and broad road surface, he does not know where he may walk because there are no characteristic targets around him, and he also cannot recognize a distant scene, and so on.

This invention solves such problems and is aimed at providing a walking auxiliary for a person with impaired vision which provides him with sufficient information of obstacles and so on when he takes a walk.

### SUMMARY OF THE INVENTION

The walking auxiliary for a person with impaired vision relating to one mode of this invention is provided with a distance-measuring means for measuring a distance to an obstacle and a transmission means for transmitting the existence of the obstacle somatosensorially or by a sound based on the stereo information of the obstacle, obtained from the distance measured by the distance-measuring means. In this invention, the distance-measuring means measures a distance to an obstacle and the transmission means transmits the existence of the obstacle somatosensorially (e.g., by the sense of touch) or by a sound based on the stereo information of the obstacle obtained from the distance measured by the distance-measuring means. Therefore, this invention fully provides information of obstacles when the person with impaired vision takes a walk.

The walking auxiliary for a person with impaired vision relating to another mode of this invention is provided with a distance-measuring means for measuring a distance to an obstacle, multiple actuators, an operational means for forming and outputting control information based on the stereo information obtained from the distance to the obstacle measured by the distance-measuring means and a controlling means for driving the actuators and transmitting the existence of the obstacle somatosensorially based on the control information. In this invention, the distance-measuring means measures a distance to an obstacle, the operational means forms and outputs control information based on the stereo information obtained from the distance to the obstacle measured by the distance-measuring means, and the controlling means drives the actuators and transmits the existence of the obstacle somatosensorially based on the control information. Therefore, this invention fully provides information of obstacles when the person with impaired vision takes a walk.

In the walking auxiliary for a person with impaired vision relating to still another mode of this invention, the operational means converts the stereo information to plane information and outputs the plane information as a control signal. In this invention, the operational means converts the stereo information obtained from the distance to the obstacle measured by the distance-measuring means to plane information and takes it as a control signal of the actuators, therefore front obstacles can be identified in a plane.

In the walking auxiliary for a person with impaired vision relating to still another mode of this invention, the operational means detects whether the person is in a state of walking based on a fluctuation of the distance to the obstacle and varies the formed plane information according to the state. In this invention, the operational means detects whether the person is in a state of walking based on a fluctuation of distance to the obstacle and varies the formed plane information according to the state, as described later.

In the walking auxiliary for a person with impaired vision relating to another mode of this invention, the operational means detects an obstacle within a predetermined distance and forms plane information of the obstacle in case the person is in a state of walking. In this invention, the operational means detects an obstacle within a predetermined distance and forms plane information of the obstacle to drive actuators in case the person is in a state of walking, thus whether the obstacle exists in a near range can be easily identified while walking.

In the walking auxiliary for a person with impaired vision relating to still another mode of this invention, the operational means adds specific information to the plane information of adjacent obstacles among obstacles within a predetermined distance and drives the actuators. In this invention, for example, if an obstacle in the vicinity of a walker exists, the operational means drives the actuators (e.g., varies the vibration frequency, increases the amplitude, etc.) so as to further distinguish obstacles in a separated position and tells the walker about a dangerous state by especially adding specific information to the plane information of the adjacent obstacles among obstacles within the predetermined distance and driving the actuators.

In the walking auxiliary for a person with impaired vision relating to still another mode of this invention, the operational means detects obstacles beyond a predetermined distance and forms plane information of the obstacles in case the person is in a standstill state. In this invention, for example, the operational means detects obstacles beyond a predetermined distance, forms plane information of the obstacles to drive actuators and tells the walker, e.g., about distant targets and so on in a case that, e.g., the person is in a standstill state.

In the walking auxiliary for a person with impaired vision relating to another mode of this invention, the plural actuators are disposed in a matrix, thus the above plane information can be reflected as it is, and the obstacle can be easily identified.

The walking auxiliary for a person with impaired vision relating to still another mode of this invention is further provided with a sound signal forming means for forming and outputting a sound signal based on the stereo information and a sound output means for converting the sound signal to a sound and outputting it, and because a guidance by sound is made in addition to the driving of the actuators, the existence of an obstacle can be identified without fail.

The walking auxiliary for a person with impaired vision relating to still another mode of this invention is provided with a distance-measuring means for measuring a distance to an obstacle, a sound signal forming means for forming and outputting a sound signal based on the stereo information obtained from the distance to the obstacle measured by the distance-measuring means and a sound output means for converting the sound signal to a sound and outputting it. In this invention, the distance-measuring means measures a distance to an obstacle, the sound signal forming means forms and outputs a sound signal based on the stereo information obtained from the distance to the obstacle measured by the distance-measuring means and a sound output means converts the sound signal to a sound and outputs it to tell the person with impaired vision about the existence of the obstacle, therefore information of the obstacles can be fully provided when the person with impaired vision takes a walk.

In the walking auxiliary for a person with impaired vision relating to another mode of this invention, the sound signal forming means forms and outputs a sound signal based on the stereo information of an obstacle within a predetermined distance. In this invention, the sound signal forming means detects an obstacle within a predetermined distance, guides the existence of the obstacle by a sound, thus the obstacle that exists in a near range can be easily identified during the walk.

In the walking auxiliary for a person with impaired vision relating to still another mode of this invention, the sound signal forming means contrasts the stereo information with pre-registered stereo information of an obstacle and, if both are consistent, it forms a sound signal corresponding to the information for specifying the obstacle. The sound output means converts the sound signal to a sound and outputs it to tell the person about what the obstacle is, therefore the obstacle can be easily identified.

In the walking auxiliary for a person with impaired vision relating to still another mode of this invention, the distance-measuring means comprises a distance sensor and a scanning means for scanning the distance sensor. In this invention, the distance-measuring means scans the distance sensor to find distances from the respective sites of the obstacle in a predetermined field range.

In the walking auxiliary for a person with impaired vision relating to another mode of this invention, the distance-measuring means is provided with a plural image pickup means disposed in different positions and a distance-measuring operation part for processing an image pickup signal from the image pickup means and obtaining a distance to the obstacle. In this invention, the distance-measuring means processes the image pickup signal from the plural image pickup means to find the distances from the respective sites of the obstacle.

In the walking auxiliary for a person with impaired vision relating to still another mode of this invention, the means and/or the actuators are mounted to a headband. In this invention, the means and so on are mounted to the headband and a guidance of the existence of obstacles is made by mounting the headband to the head.

### BRIEF DESCRIPTION OF THE DRAWINGS

FIG. 1 is a block diagram showing the circuit construction of an auxiliary relating to Embodiment 1 of this invention.

FIG. 2 is a block diagram of an auxiliary incorporated with the circuit construction of FIG. 1.

FIG. 3 is an oblique drawing with extracted actuator array of FIG. 1.

FIG. 4 is a circuit block diagram showing the relationship between the actuator control unit and the actuator array of FIG. 1.

FIG. 5 is a flow chart showing the actions of the image processing unit of FIG. 1.

FIG. 6 is a diagram showing the method for finding the distance to the picked up object in the image processing unit of FIG. 1.

FIG. 7 is a schematic diagram showing an example of a bicycle ahead of user.

FIG. 8 is a diagram showing an example of a hole and tree ahead of user.

FIG. 9 is a diagram showing an example of a ball flying at user.

FIG. 10 is a block diagram showing the circuit construction of an auxiliary relating to Embodiment 6 of this invention.

FIG. 11 is a block diagram showing the circuit construction of an auxiliary relating to Embodiment 7 of this invention.

FIG. 12 is a block diagram showing the circuit construction of an auxiliary relating to Embodiment 8 of this invention.

### DETAILED DESCRIPTION OF THE PREFERRED EMBODIMENTS

Embodiment 1

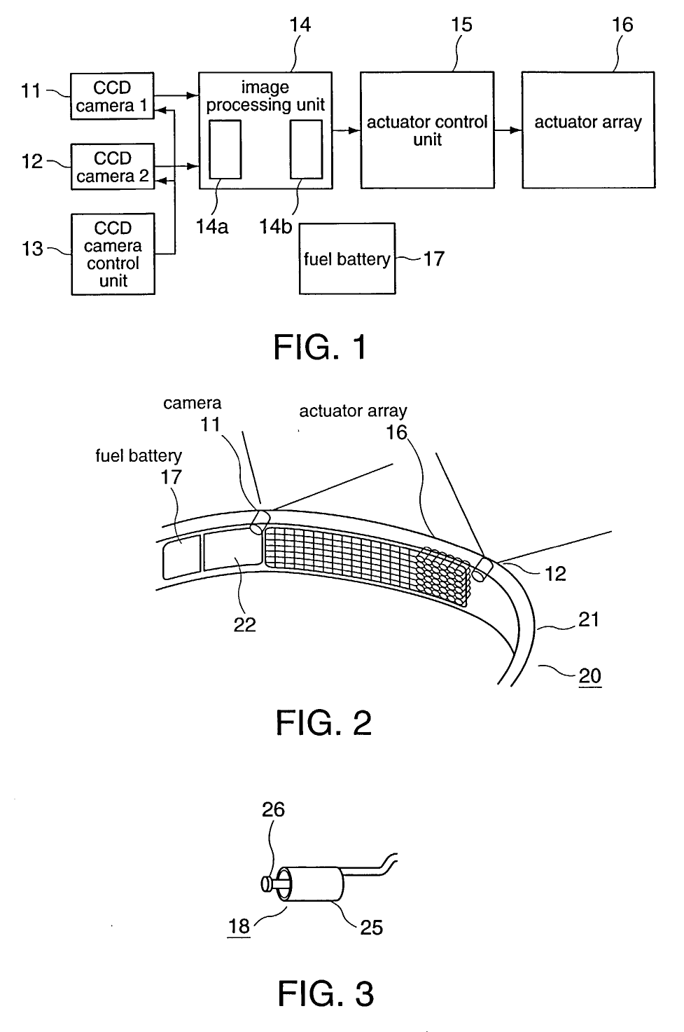

FIG. 1 is a block diagram showing the circuit construction of a walking auxiliary for a person with impaired vision relating to Embodiment 1 of this invention. The walking auxiliary for a person with impaired vision (called “auxiliary” hereafter) comprises two CCD cameras 11, 12, a CCD camera control unit 13, an image processing unit 14, an actuator control unit 15, an actuator array 16, and a fuel battery 17. The two CCD cameras 11, 12 controlled by the CCD camera control unit 13, pick up images at different angles, respectively and output their image pickup signals to the image processing unit 14. The image processing unit 14 is composed of a distance-measuring operation part 14a and a control signal forming operation part 14b. Although its details will be described later, the image processing unit 14 inputs the image signals from the CCD cameras 11, 12 to perform image processing and measure a distance, forms the stereo image information (three-dimensional information), further converts the stereo information to two-dimensional information, forms a control signal for controlling the actuator array 16 and outputs it to the actuator control unit 15. The actuator control unit 15 drives the actuator array 16 and tells a user about the surrounding conditions picked up by the two CCD cameras 11, 12.

FIG. 2 is a block diagram of an auxiliary 20 incorporated with the circuit construction of FIG. 1. This auxiliary 20 is provided with a headband 21, and the two CCD cameras 11, 12 are mounted to this headband 21 at a predetermined spacing. The actuator array 16 is mounted between the two CCD cameras 11, 12. A fuel battery 17 is mounted to this headband 21, and a control unit 22 with built-in CCD camera control unit 13, image processing unit 14 and actuator control unit 15 is mounted to this headband 21. This auxiliary 20 is used in a state in which the headband 21 is attached to the forehead of a user.

FIG. 3 is an oblique drawing with one extracted actuator 18 of the actuator array 16. In the actuator 18, an exciting coil (not illustrated) is built in a cylinder 25 of about 1 mm in diameter, and a protrusion 26 supported movably in its axial direction is arranged in the cylinder 25. The protrusion 26 moves on the forehead side of the user by feeding an exciting current to the exciting coil of the cylinder 25 to transmit information to a user somatosensorially (e.g., through the sense of touch).

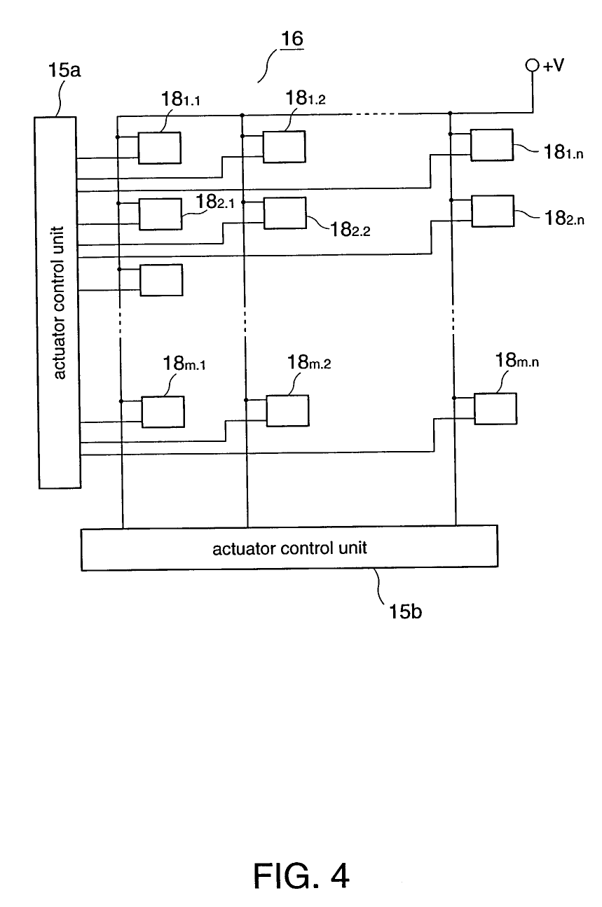

FIG. 4 is a circuit block diagram showing the relationship between the actuator control unit 15 and the actuator array 16. The actuator control unit 15 is composed of control units 15a and 15b. In the actuator array 16, actuators 18 (18_{1.1}, 18_{1.2}. . . , 18_{1.n}, 18_{2.1}, 18_{2.2}. . . , 18_{2.n}, . . . 18_{m.1}, 18_{m.2}. . . , 18_{m.n}) are disposed in a matrix, the control unit 15a controls the row direction and the control unit 15b controls the column direction, of this actuator array 16.

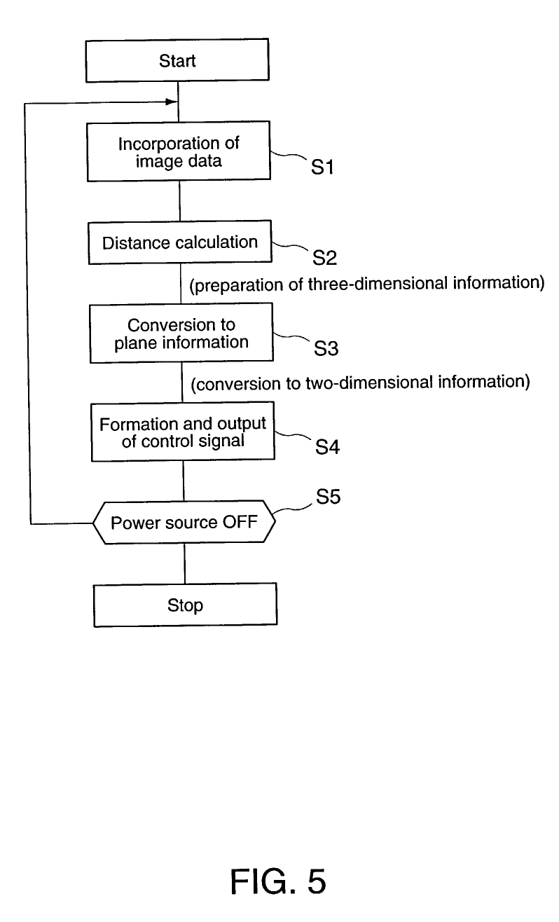

FIG. 5 is a flow chart showing the actions of the image processing unit 14.

(S1) The distance-measuring operation part 14a of the image processing unit 14 takes in image pickup signals which are picked up by the two CCD cameras 11, 12 at different angles, respectively.

(S2) The distance-measuring operation part 14a of the image processing unit 14 forms a three-dimensional image based on the image pickup signals. Therefore, first, it finds the distances from the sites of a picked-up object based on the image pickup signals.

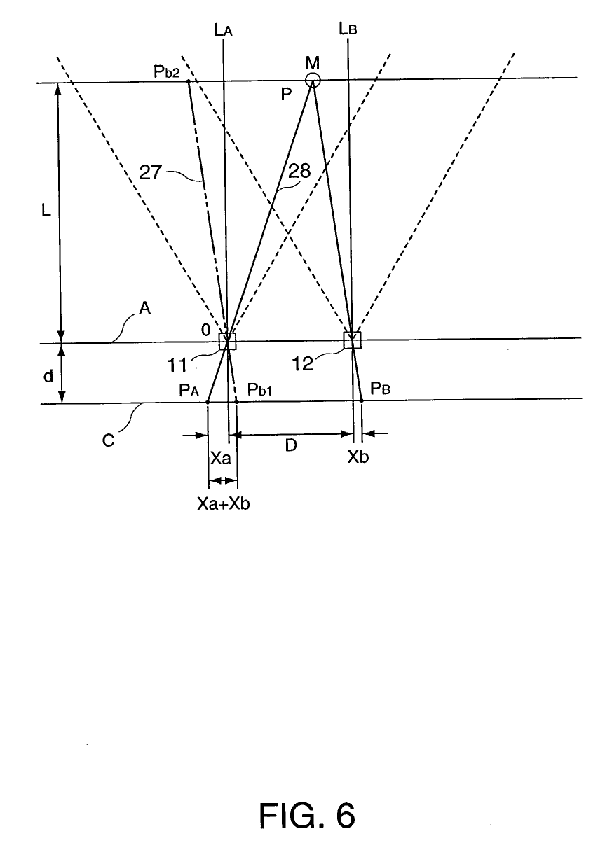

FIG. 6 is a diagram showing a method for finding a distance to a picked-up object. For example, some obstacle M is positioned at an illustrated point P. In this case, the position of point P comes into the field of view of both CCD cameras 11, 12. Accordingly, the CCD cameras 11, 12 project images of the obstacle M on respective imaging planes. In the CCD camera 11, an image of the obstacle M is formed on a point P_{A} of an imaging plane C. Here, a deviation from the optical axis LA of this CCD camera 11 to the point P_{A} is taken as xₐ. In the CCD camera 12, an image of the obstacle M is formed on a point P_{B} of the imaging plane C. Similarly to the CCD camera 11, a deviation between the optical axis LB of this CCD camera 12 to the point P_{B} is taken as x_{b}. The distance-measuring operation part 14a of the image processing unit 14 calculates the above deviations xₐ and x_{b}, respectively.

Next, it is supposed that the optical axis of either one of the CCD cameras 11 and 12 is moved in parallel to make the optical axes LA and LB consistent with each other. Here, the optical axis LB of the CCD camera 12 is taken to be consistent with the optical axis LA of the CCD camera 11. If the optical axis LB is made consistent with the optical axis LA, a straight line connecting the obstacle M and the point P_{B} of the imaging plane C is expressed by a double-dashed line 27 on the CCD camera 11 side. In this way, ΔOP_{A}P_{b1} and ΔOPP_{b2} can be formed between a straight line 28 connecting the obstacle M and the point P_{A} of the imaging plane and the above double-dashed line 27 on the CCD camera 11 side. These ΔOP_{A}P_{b1} and ΔOPP_{b2} are similar figures, therefore the following equation is established.

L/d=D/(xₐ+x_{b}) (1)

This equation (1) is deformed, then

L=d·D/(xₐ+x_{b}) (2)

In the way described above, the distance-measuring operation part 14a of the image processing unit 14 gives three-dimensional information by finding the distances for the picked up object in order. Moreover, the distance-measuring operation part 14a of the image processing unit 14 makes detection of the obstacle M (detection that the obstacle M (picked-up object) of image signal of the CCD camera 11 and the obstacle M (picked-up object) of image signal of the CCD camera 12 are same object) and performs the above distance calculation. For example, if the head is slightly moved immediately after a power source is input, the visual field position of the distance-measuring operation part 14a changes, and the objects in the images obtained by the two CCD cameras 11 and 12 move in connection with the movement of head and the distance. It determines whether they are the same object by a calculation from this movement. Namely, it detects the obstacle M by use of the fact that the quantity of the position change of the left and right images to the movement of the head always has a constant correlation if they are the same object (the calculation result takes an inherent correlation value) and the calculation result deviates from the correlation value if they are not the same object, when fixing the correlation of the two CCD cameras 11 and 12.

(S3) The control signal forming operation part 14b of the image processing unit 14 converts the above three-dimensional information to two-dimensional information. For example, a picked-up object located within a predetermined distance is extracted to give two-dimensional information of the picked-up object. At that time, the contour of the picked-up object is obtained to give two-dimensional information, when painting over the inside of the contour.

(S4) The control signal forming operation part 14b of the image processing unit 14 forms a control signal for controlling the actuator array 16 based on the above two-dimensional information. The actuator control unit 15 (15a, 15b) drives the actuator array 16 based on the control signal. For example, if the obstacle exists within a predetermined distance, an exciting current is fed to the actuator array 16 in a region equivalent to the two-dimensional shape of the obstacle. Protrusions 26 take a protruding action and tell the user about the existence of the obstacle. Since the actuators 18 are disposed in a matrix in the actuator array 16 as described above, the user can identify the shape of the obstacle by driving the actuators 18 in response to the plane shape of the obstacle.

(S5) The image processing unit 14 repeats the above processes (S1) to (S4) until the power source turns off (or until a command of stop).

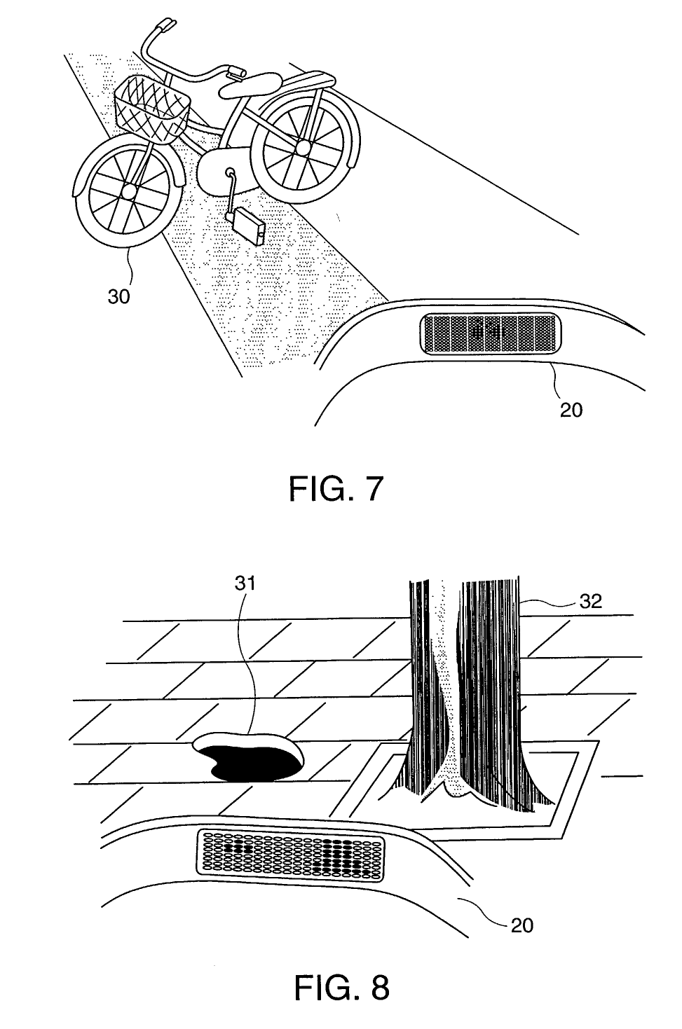

FIG. 7 is a schematic diagram showing an example of a bicycle 30 placed ahead. In this Embodiment 1, when the bicycle 30 is placed ahead, first, the distance is measured to obtain its three-dimensional information, then the three-dimensional information is converted to two-dimensional information, and the actuator array 16 existing in a region corresponding to the two-dimensional information is driven to tell the user about the existence of the bicycle 30. Then, the region expands in a walking state, therefore it is known that the user is approaching the obstacle.

Embodiment 2

In the above Embodiment 1, an example wherein the control signal forming operation part 14b of the image processing unit 14 finds the contour of a picked-up object and gives the two-dimensional information in a state of painting over the inside of the contour was illustrated, however, for example, when a dent having a given size appears in a flat region (a state in which the distance only in a given area becomes far), it determines the dent as a hole and forms a control signal different from the above obstacle. For example, it forms and outputs a control signal for vibrating the actuator array 16 at a predetermined period. The actuator control unit 15 (15a, 15b) drives the actuator array 16 and vibrates the protrusions 26 based on the control signal.

In this Embodiment 2, FIG. 8 is a drawing showing an example of a case where a hole 31 and a tree 32 exist ahead. The image processing unit 14 detects the hole 31 and forms a control signal for vibrating the actuator array 16 in a region corresponding to the hole, and the actuator control unit 15 (15a, 15b) drives and vibrates the actuator array 16 based on the control signal. For the tree 32, as illustrated in the above Embodiment 1, the image processing unit 14 forms a control signal for vibrating the actuator array 16 in a region corresponding to the tree, and the actuator control unit 15 (15a, 15b) protrudes the protrusions 26 of the actuator array 16 based on the control signal.

In the above example, for instance, when the tree becomes even closer, the image processing unit 14 forms a control signal different from in a separated state (amplitude, frequency) to tell the user about an emergency and actuates the actuator array 16 not as usual to tell the user about an emergency.

Embodiment 3

In finding the contour of a picked-up object, the control signal forming operation part 14b of the image processing unit 14 stores the data in a time series, e.g., when some object flies to a user, it detects the flying object by use of the fact that the contour increases in the time series. Then, the control signal forming operation part 14b of the image processing unit 14 forms a control signal for vibrating the actuator array 16 in a region corresponding to the flying object, and the actuator control unit 15 (15a, 15b) drives the actuator array 16 and vibrates the protrusions 26 based on the control signal. The frequency of vibration is set to, e.g., a higher frequency than the frequency for the above hole to increase the emergency.

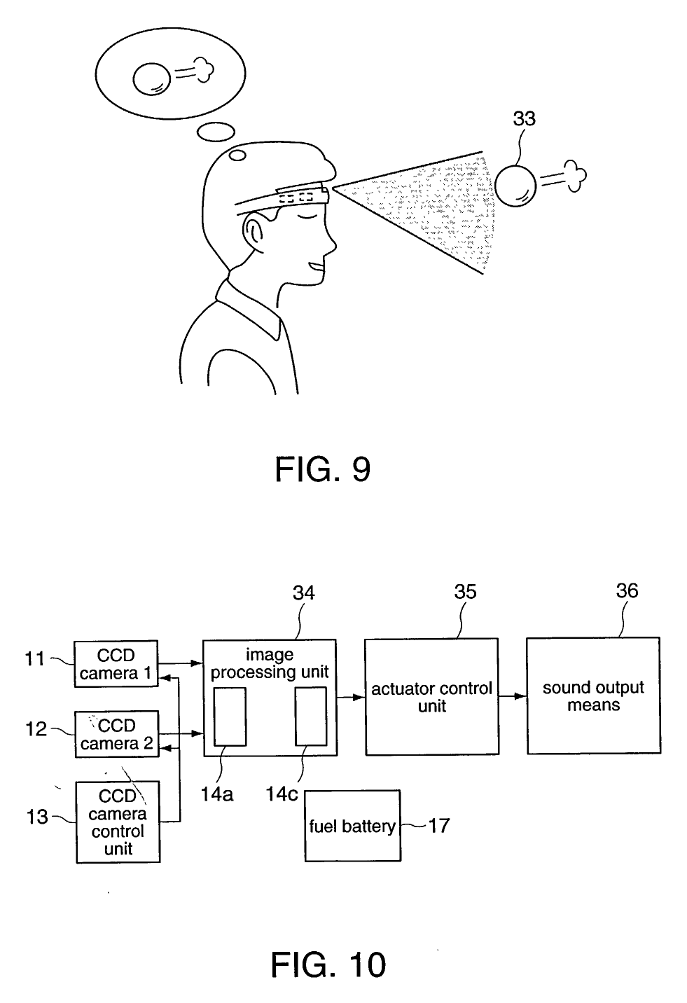

FIG. 9 is a diagram showing an example of a case where a ball 33 is flying. The control signal forming operation part 14b of the image processing unit 14 detects the ball 33 (flying object) and forms a control signal for vibrating the actuator array 16 of a region corresponding to the ball, and the actuator control unit 15 (15a, 15b) drives the actuator array 16 and vibrates the protrusions 26 based on the control signal. Thereby the user can identify the fact that something is flying at him.

Embodiment 4

How to cope with an obstacle is different in each state when a user is walking or standing still. When the user is standing still, for example, the control signal forming operation part 14b of the image processing unit 14 can correspond to a case of pressing danger by detecting 1. objects of a predetermined area at a distance of 5 m or more and 2. objects in motion, recognizing a state of relatively separated surroundings (identifying what state of place he is in) and detecting the objects in motion. Moreover, in finding the contour of a picked-up object, the control signal forming operation part 14b of the image processing unit 14 stores the data in a time series and determines whether the user is walking or stopping based on whether the contour enlarges or not. Furthermore, when the control signal forming operation part 14b of the image processing unit 14 detects that the user is walking and detects a flying object, although both contours of the picked-up objects enlarge, it can discriminate between them, because the entire contour enlarges in the former case and a part of contour enlarges in a short time in the latter case.

Embodiment 5

In the above Embodiments 1-4, an example wherein the existence of an obstacle is told to a user by driving the actuator array 16 was illustrated, but the existence of an obstacle may also be told to a user by a sound.

FIG. 10 is a block diagram showing the circuit construction of an auxiliary 20 relating to Embodiment 5 of this invention. It comprises two CCD cameras 11, 12, a CCD camera control unit 13, an image processing unit 34, a sound signal forming unit 35, a sound output means (e.g., an earphone) 36 and a fuel battery 17. The two CCD cameras 11, 12 are controlled by the CCD camera control unit 13, pick up images at different angles, respectively and output the image pickup signals to the image processing unit 34. The image processing unit 34 is composed of a distance-measuring operation part 14a and a stereo shape discriminating operation part 14c. Similarly to the above case, the distance-measuring operation part 14a inputs the image signals from the CCD cameras 11, 12 for image processing, measures a distance and forms the stereo image information (three-dimensional information). The stereo shape discriminating operation part 14c contrasts the stereo image information with pre-stored stereo image information and determines what kind of information the stereo image information is. For example, it is known that an obstacle is a tree and it is also known how many meters this tree is located ahead of the user, therefore this information is output to the sound signal forming unit 35. The sound signal forming unit 35 forms a sound signal based on the information and generates a sound, “There is a tree 3 m ahead to the right”, from the sound output means 36 to tell the existence of the obstacle to the user.

This Embodiment 5, which is useful in case the moving path of a user is previously known, pre-stores stereo image information (three-dimensional information) about a moving path and the surrounding obstacles and can particularly specify the obstacles to give guidance to the user by contrasting the stereo image information with the stereo image information (a three-dimensional information) formed by the image signals from the CCD cameras 11, 12. Moreover, even if this Embodiment 5 cannot particularly specify the obstacles, it can tell the user about the existence of the obstacles.

Embodiment 6

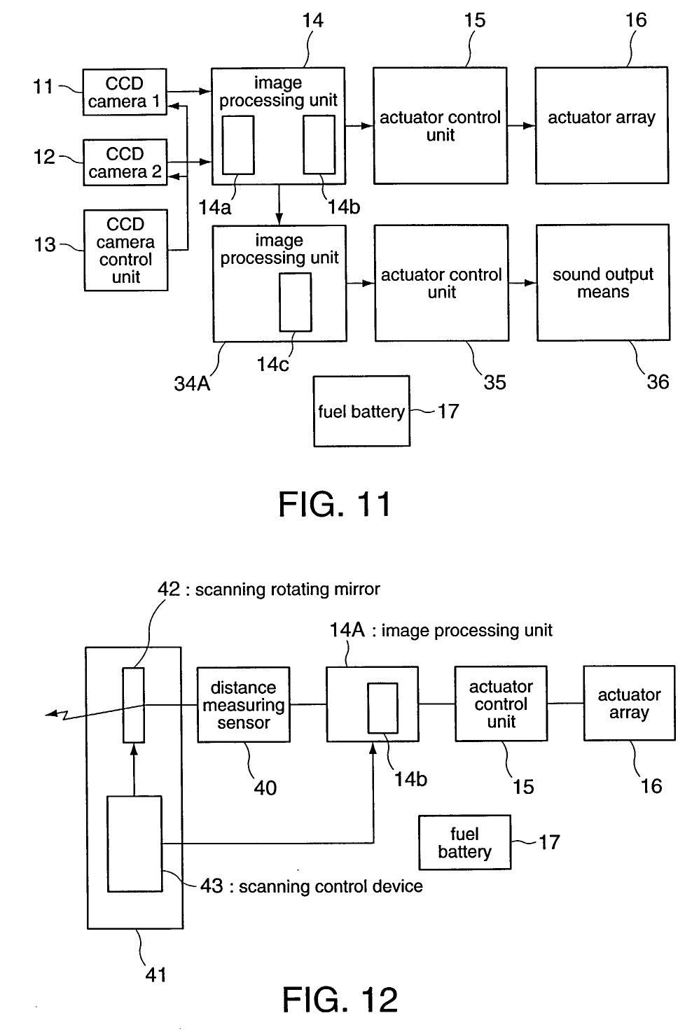

FIG. 11 is a block diagram showing the circuit construction of an auxiliary 20 relating to Embodiment 6 of this invention. This Embodiment 6 comprises two CCD cameras 11, 12, a CCD camera control unit 13, an image processing unit 14, an actuator control unit 15, an actuator array 16, a fuel battery 17, an image processing unit 34 and a sound signal forming unit 35, and a sound output means (e.g., an earphone) 36. It combines the above embodiment of FIG. 1 and the above Embodiment of FIG. 10.

In this auxiliary 20, the two CCD cameras 11, 12 controlled by the CCD camera control unit 13, pick up images at different angles, respectively and output their image pickup signals to the image processing unit 14. The image processing unit 14 inputs the image signals from the CCD cameras 11, 12 for image processing, forms stereo image information (three-dimensional information), further converts the stereo image information to two-dimensional information to form a control signal for controlling the actuator array 16 and outputs it to the actuator control unit 15. The actuator control unit 15 drives the actuator array 16 and tells a user about surrounding conditions picked up by the two CCD cameras 11, 12. The image processing unit 34A (the stereo shape discriminating operation part 14c) inputs the stereo image information (three-dimensional information) from the image processing unit 14, then contrasts the stereo image information with the pre-stored stereo image information to determine its type. Similarly to the above case, for example, if it is known that an obstacle is a tree and it is also known how many meters this tree is located ahead of the user, therefore its information is output to the sound signal forming unit 35. The sound signal forming unit 35 forms a sound signal and generates a sound, “There is a tree 3 m ahead to the right”, from the sound output means 36 to tell the existence of the obstacle to the user.

This embodiment transmits more reliable information because it tells the user about the existence of obstacles through both the actuator array 16 and the sound output means 36. Moreover, the above Embodiments 2 to 4 are also similarly applied to this Embodiment 6.

Embodiment 7

The examples wherein the measurement of distance to an obstacle was made by using two CCD cameras 11, 12 were illustrated in the above embodiments, but a distance sensor may also be used in place of the two CCD cameras 11, 12. In this case, the distance sensor is scanned to pick up images of a predetermined region ahead of a user. After the distance to the obstacle is obtained, processing is same as in the above Embodiment 1.

FIG. 12 is a block diagram showing the circuit construction of an auxiliary 20 relating to Embodiment 7 of this invention. In the auxiliary 20 of this Embodiment 7, a distance sensor 40 and a scanning mechanism 41 for scanning the distance sensor 40 are provided in place of the two CCD cameras 11, 12. The scanning mechanism 41 is composed of a scanning rotating mirror 42 and a scanning control device 43. The scanning control device 43 measures a distance to the obstacle ahead of a user by controlling the scanning rotating mirror 42 to scan the measured sites of the distance sensor 40. Similarly to the above Embodiment 1, an image processing unit 14A (control signal forming operator part 14b) forms a control signal and outputs it to an actuator control unit 15 to drive an actuator array 16 based on the distance to the obstacle (three-dimensional information). This Embodiment 7 may also be combined with the embodiment of FIG. 10.

Embodiment 8

Moreover, the examples of a fuel battery as power source were illustrated, but other power sources such as a dry battery, secondary battery or others may also be used in this invention. Furthermore, the examples mounted with various tools to a headband were illustrated, but they may also be mounted to a hat or clothes and so on.

As described above, this invention provides sufficient information of obstacles or the like when a person with impaired vision takes a walk because it is provided with a distance-measuring means for measuring a distance to an obstacle and a transmission means for transmitting the existence of the obstacle somatosensorially or by a sound so that it measures the distance to the obstacle and transmits the existence of the obstacle somatosensorially or by a sound based on the stereo information of the obstacle obtained from the distance.

The entire disclosure of Japanese Application No. 2001-281519, filed Sep. 17, 2001 is incorporated by reference.

What is claimed is:

1. A walking auxiliary for a person with impaired vision, comprising:
a distance-measuring means for measuring a distance to an obstacle; and
a transmission means for transmitting an existence of the obstacle somatosensorially or audibly, based on stereo information of the obstacle obtained according to the distance measured by the distance-measuring means.

2. A walking auxiliary for a person with impaired vision, comprising:
a distance-measuring means for measuring a distance to an obstacle;
multiple actuators;
an operational means for forming and outputting control information based on stereo information obtained from the distance to the obstacle measured by the distance-measuring means; and
a controlling means for driving the actuators and transmitting an existence of the obstacle somatosensorially based on the control information.

3. The walking auxiliary for a person with impaired vision described in claim 2, wherein the operational means converts the stereo information to plane information and outputs the plane information as a control signal.

4. The walking auxiliary for a person with impaired vision described in claim 3, wherein the operational means detects whether the person is in a state of walking based on a fluctuation of the distance to the obstacle and varying the formed plane information according to the state.

5. The walking auxiliary for a person with impaired vision described in claim 4, wherein the operational means detects an obstacle within a predetermined distance and forms plane information of the obstacle in case the person is in the state of walking.

6. The walking auxiliary for a person with impaired vision described in claim 5, wherein the operational means adds specific information to the plane information of adjacent obstacles among obstacles within the predetermined distance and drives the actuators.

7. The walking auxiliary for a person with impaired vision described in claim 4, wherein the operational means detects obstacles beyond a predetermined distance and forms plane information of the obstacles in the event that the person is in a standstill state.

8. The walking auxiliary for a person with impaired vision described in claim 2, wherein the multiple actuators are disposed in a matrix.

9. The walking auxiliary for a person with impaired vision described in claim 2, further comprising:
a sound signal forming means for forming and outputting a sound signal based on the stereo information; and
a sound output means for converting the sound signal to a sound and outputting the sound.

10. A walking auxiliary for a person with impaired vision, comprising:
a distance-measuring means for measuring a distance to an obstacle;
a sound signal forming means for forming and outputting a sound signal based on stereo information obtained according to the distance to the obstacle measured by the distance-measuring means; and
a sound output means for converting the sound signal to a sound and outputting the sound.

11. The walking auxiliary for a person with impaired vision described in claim 10, wherein the sound signal forming means forms and outputs a sound signal based on the stereo information of the obstacle within a predetermined distance.

12. The walking auxiliary for a person with impaired vision described in claim 10, wherein the sound signal forming means contrasts the stereo information and pre-registered stereo information of the obstacle and, if the stereo information and the pre-registered stereo information are consistent with each other, the sound signal forming means forms a sound signal corresponding to information specifying the obstacle.

13. The walking auxiliary for a person with impaired vision described in claim 2, wherein the distance-measuring means comprises a distance sensor and a scanning means for scanning the distance sensor.

14. The walking auxiliary for a person with impaired vision described in claim 2, wherein the distance-measuring means is provided with plural image pickup means disposed in different positions and a distance-measuring operation part for processing image pickup signals from the image pickup means and finding a distance to the obstacle.

15. The walking auxiliary for a person with impaired vision described in claim 2, wherein at least one of a first group including the distance-measuring means, operational means, and controlling means and a second group including the actuators is mounted to a headband.

16. The walking auxiliary for a person with impaired vision described in claim 10, wherein the distance-measuring means comprises a distance sensor and a scanning means for scanning the distance sensor.

17. The walking auxiliary for a person with impaired vision described in claim 10, wherein the distance-measuring means is provided with plural image pickup means disposed in different positions and a distance-measuring operation part for processing image pickup signals from the image pickup means and finding a distance to the obstacle.

18. The walking auxiliary for a person with impaired vision described in claim 10, wherein at least one of a first group including the distance-measuring means, operational means, and controlling means and a second group including the actuators is mounted to a headband.

19. A walking auxiliary for a person with impaired vision comprising:
a base;
a sensor mounted to the base and generating an image signal of an obstacle;
an image processing unit communicating with the sensor and determining a distance to the obstacle based on the image signal and generating a control signal based on the distance; and
an actuator communicating with the image processing unit and informing the person of the distance based on the control signal.

20. The walking auxiliary of claim 19 wherein the image processing unit further comprises:
means for forming a three-dimensional image information signal; and
means for converting the three-dimensional image information signal to a two dimensional image information signal.

21. The walking auxiliary of claim 19 wherein the image processing unit further comprises:
means for accounting for a state when the person is walking; and
means for accounting for a state when the person is standing still.

22. The walking auxiliary of claim 19 wherein the image processing unit further comprises:
means for accounting for a state when a head of the person is moving.

23. The walking auxiliary of claim 19 wherein the actuator further comprises a somatosensory actuator.

24. The walking auxiliary of claim 23 wherein the somatosensory actuator further comprises means for informing the person of different obstacle scenarios including at least two of the group including projecting obstacles, recessed obstacles, and flying obstacles.

25. The walking auxiliary of claim 24 wherein the means for informing the person of different obstacle scenarios includes means for modifying an actuated region size.

26. The walking auxiliary of claim 19 wherein the actuator further comprises an audible actuator.

27. The walking auxiliary of claim 26 wherein the audible actuator further comprises means for informing the person of different obstacle scenarios including at least two of the group including projecting obstacles, recessed obstacles, and flying obstacles.

28. The walking auxiliary of claim 27 wherein the means for informing the person of different obstacle scenarios includes means for modifying at least one of amplitude and frequency.

29. The walking auxiliary of claim 19 wherein said sensor further comprises:
a first CCD camera mounted to the base and generating a first image signal of an obstacle at a first angle; and
a second CCD camera mounted to the base at a location spaced apart from the first CCD camera and generating a second image signal of the obstacle at a second angle; and
wherein the image processing unit determines the distance to the obstacle based on the first and second image signals.

30. The walking auxiliary of claim 19 wherein said sensor further comprises a distance sensor mounted to the base and generating the image signal.

31. The walking auxiliary of claim 19 wherein said base further comprises a headband.
